(19) United States
(12) Patent Application Publication
(10) Pub. No.: US 2019/0197451 A1
(43) Pub. Date: Jun. 27, 2019

(54) SUPPLY CHAIN MANAGEMENT SYSTEM THROUGH INTEGRATED SOFTWARE AND MOBILE SUPERMARKETS

(71) Applicant: MOHANADAS BALASINGHAM, New South Wales (AU)

(72) Inventor: MOHANADAS BALASINGHAM, New South Wales (AU)

(21) Appl. No.: 16/328,760

(22) PCT Filed: Sep. 5, 2017
(86) PCT No.: PCT/AU2017/050961

§ 371 Date: Feb. 27, 2019

Related U.S. Application Data
(60) Provisional application No. 62/384,399, filed on Sep. 7, 2016.

(51) Int. Cl. G06Q 10/06; G06Q 30/08

(52) U.S. Cl. CPC G06Q 10/06315; G06Q 30/08

(57) ABSTRACT

This is a new novel system of supply management with mobile delivery units and integrated software and comprises of Suppliers with supplier portal (102); with Supplier bidding portal (101); warehouse with warehouse portal (103); Contractor with contractor portal (104); quality assessor with Quality assessor portal (105); distributor/distribution channel with distributor portal (106); mobile supermarket (107); Courier service with courier portal 108; Shuttle service with shuttle portal (109); Tracking service tracking portal (110); Holistic integrated accounting package with accountants to monitor via accountant portal (112); New concept customer portal Sub-menus, sub-sub menu, sub-sub-sub menu, sub-sub-sub-sub menu, sub-sub-sub-sub-sub menu going down to product with description and prices for the customer to select the product quickly (111); warehouse robot with Robot portal (113); mobile supermarket with Mobile supermarket interphase, mobile supermarket Robot with mobile supermarket robot portal (114); Master Admin with Master admin/master CRM portal; mobile friendly mobiles apps for android, ios and windows; and optional pharmacy portal with pharmacist interphase. A method for supply chain management system with Mobile Supermarket/Distribution units with Integrated accounting Software Portal (207) to manage the portal including consumer, distributor, warehouse, supplier, quality assessor, contractor, accounts, third party, “Customer Points Portal” and all management portals in an intricate manner is also disclosed.

### CROSS REFERENCE TO RELATED APPLICATIONS

This is a complete/non-provisional specification for earlier filed provisional patent application No. 62/384,399 on Sep. 7, 2016

### FEDERALLY SPONSORED RESEARCH AND DEVELOPMENT

Not applicable

### MICROFICHE

Not applicable

### BACKGROUND OF THE INVENTION

### Field of the Invention

The present invention is an integrated method with complex processes with integrated software that deals with the novel management of all consumer, distributor, mobile supermarket, warehouse, supplier, accounts and all managements. It presents supplier interphase, warehouse interface, warehouse-stock storage interface, warehouse Robot interphase, distributor interface, distributor-stock interface, customer-distributor-warehouse interface, accounting interface with mobile supermarket and storage unit with a delivery trolley where all these interfaces are independently working and at the same time interlinked by a common software platform.

This system is a novel method of automated delivery in mobile Supermarkets and Mobile delivery units which get delivered to a Customer's address almost instantly as soon as the orders are made with flexible payment options available to the customer and the storage/delivery unit is blended nicely in the kitchen or the storage of the customer.

When the usage of the storage/delivery unit is over, the distributor picks the empty storage unit with the next order and is recycled for the next order.

The option of supplier bidding for spaces in the warehouse and automated stocking up of the products in the distributor's departments and storage unit is also available.

### Background of the Invention

The science and technology has advanced in leaps and bounds and the quality of life has increased significantly. The needs of consumerism and commerce have also been met in a variety of improvements including online delivery of products thus saving of time and labor. This is totally a new concept of marketing strategy, a new concept of supply chain management and a new concept of automated integrated supply and delivery and a new forms of Supply chain delivery management. The present new business model comes along that allows a fast and efficient market proliferation locally and around the world. Present sales model for Supply Chain requires lot of manpower for pick packing and wastage of resources. There are many manual processing are involved. Supermarket concept requires a lot of space for display. Consumers have to come physically to a particular place to purchase things even to purchase single commodity of small amount. It could be a far-away place for some customers. Customers have to either walk or use a public or private transport incurring extra expenditures to get to the store or Supermarket. If the consumers use their own vehicle, they will have to find a convenient parking spot to park their vehicle and then to get to the shop or Supermarket. Once they go to a shop or Supermarket, they spend at least 30 minute to an hour on the average to go up and down the aisles to look for what they want. This involves a lot of time wastage and there is also lot of overhead expenditure in maintaining modern supermarkets. Supermarkets require lot of space to display good. There are more employees and all employees have to be insured against accidents and injuries at work. When they get to the supermarkets, consumers spend a lot of time trying go up and down the aisles to find the products they want.

Once they buy, they again have to queue up at the checkout to pay and carry their products home. By car they will have to travel to the Supermarket which can take anywhere from 15 minutes. Going up and down all the isles and waiting at the checkout in the supermarket which will take minimum 30 minutes. Loading the car and driving back home, take the groceries back in the pantry, all take more than an hour or so. Because of too many overheads, cost of products is high. Supermarkets also put the prices up make a lot of Profit. Supermarkets demand low prices from the suppliers and squeeze the profits out of the suppliers. This could be utilized in a better way with the hard to find family time, sports and leisure activities, visiting friends and relatives. Overall it is a slow process. Some of the staffs are very partial. On the other hand, some supermarkets offer home Delivery. People can go online and buy things or they go to supermarkets, buy things and ask the Supermarkets to deliver home at a cost. But the overall process is again time consuming and the delivery costs more money. There are supermarket systems which present a similar market model and some of the patented literature is described below.

A number of various systems and methods are available in the prior art which discuss a method of supplying goods products to the consumer. Prior art, WO2006090360 A2 discloses methods for delivery of classified goods and serviced items through a vehicle drive-thru facility, the facility having a plurality of vehicle drive-thru pick-up portals for goods or services orderable via an electronic or computer medium. The present invention comprises, in another embodiment, a process for operating a multi-lane, drive-thru, consolidated retail or commercial supercenter mall featuring specialized facility designs, high-speed order processing, warehouse management, order consolidation and delivery system of amalgamated classified goods or services. The present invention is adapted to apply a blend of shared staffing and shared services provision, information technology and enterprise management tools, and integrated process designs to meet the needs of a variety of tenant businesses operating within a single unit. This is a similar functionality but it only provides for a computerized trolley and the physical delivery element is not present. Many other features like automatic supplier bidding, automated stacking of products etc. is not present like the present inventive model. Hence, it is not conflicting with the present system.

Another prior art patent, US20100280918 A1 is a personal automation and shopping method for a buyer placing an order from product inventory, each product bearing a unique code comprising the steps of: selecting products desired for purchase by the buyer; creating an order list of said selected products with said unique code; capturing each unique code and entering said code in electronic memory; retrieving each product on said list from said inventory; comparing each retrieved product code with said product codes on the order list; identifying product codes of retrieved products which do not match the product code on said order list; identifying any omitted products from said order list which are not stored in said inventory and retrieving the omitted products; eliminating said retrieved products which do not match the product codes on said order list; locating and retrieving the products which do match the product code; identifying products which are not available in said inventory; creating a list of products which were not available in said inventory and providing the list of unavailable items to the buyer; marshalling the retrieved products in one location for the buyer and; transferring said retrieved products to the buyer's possession.

Yet another prior art patent, WO2010019852 A2 presents supply chain management system comprising: a network comprising one or more server devices and memory storage apparatus; a plurality of retail facilities connected to the network, each retail facility having consumer information processing equipment connected to the network, wherein the consumer information processing equipment comprises a plurality of in-store consumer interface devices (CIDs); a plurality of remote consumer devices connected to the network for use by consumers in locations other than the plurality of retail facilities and enabled to receive information from the network and to submit information on the network; a plurality of seller devices connected to the network for use by sellers and enabled to receive information from the network and to submit information on the network, wherein the plurality of seller devices comprise one or more of the following: retail facilities devices, manufacturer devices, marketer devices, supplier devices; a virtual trading room associated with the sellers and consumers, the virtual trading room: storing on the network memory storage apparatus: consumer information collected from the consumers via the plurality of remote consumer devices and the plurality of in-store CIDs; seller information collected from sellers and the plurality of retail facilities; providing the consumer information and the seller information to at least one of the following: a remote consumer device; an in-store CID. However, the above prior arts again have a different functionality and do not disclose the features of the present invention. Yet another prior art patents, PCT Patent WO2006126996 A1 and US 20070187183 A1 do present a near technology providing physical delivery of goods however it does not provide automated delivery of storage goods in the trolley as styled in the present invention.

From the study of the prior art, it is clear that the present market model with Warehouse that is automated and Mobile Supermarkets that is automated with integrated software system that connects to Supplier, warehouse, distributors and customers with integrated accounting package is not found with the same functionality and features in the prior art. The present supply chain management is an improvement in the sense that is more consumers friendly because it requires less overhead, saving more for the customer, reduce fuel wastage, less infrastructure, less manpower to stock items/monitor items/checkout etc., less wastage of time, energy and fuel, faster supply, accountability among different units due to connectivity and communication. This system reduces overhead expenditures of the whole process of distribution. Therefore, the present invention is personally and commercially an advantage over what already existed in prior art.

How the invention solves this problem:

1. Instant Delivery of all goods at an all-time record low time [within 30 Minutes] at no cost of delivery to customers.

2. Customer satisfaction.

3. Customer need not go to the shop and waste time in buying the product.

4. Customer has more family time.

5. Integrated System of software that Connect all different Entities through a common platform of integrated Software.

6. Option to purchase via Virtual Shop environment.

7. Easy to use system.

8. Minimal Overhead Expenses.

9. Product at the customer's doorstep delivered almost instantly. Product also can be delivered at the time requested by the Customer.

10. All products delivered in an elegant Storage trolley/Cabinet that will blend with the Kitchen.

Advantages of the present invention:

1. Fastest and Efficient Delivery: This is faster than any other present mode of delivery anywhere in the world and are delivered to customers at no extra cost.

2. Products are delivered fresh and hot.

3. Customers order the products from any electronic device 13 Laptop, PC, Tablet, Mobile or even customers can call over the phone.

4. Products ordered are delivered via Automated product dispensing systems at the distribution Channels/Mobile Delivery units, which will be the fastest mode of delivery.

5. The warehouse will have automated supplier channels for suppliers to deliver goods and Automated Distribution Channels to distribute to Distribution portal.

6. New Marketing Strategy.

7. New concept of Business model.

8. No accounting headaches. All accounts are done Automatically via the integrated accounting software.

9. No manual processing of bills, No accounts receivables, No accounts Payable.

The limitations and non-effectiveness of the prior art has been overcome by the present invention as described below.

### SUMMARY OF THE INVENTION

In the view of the foregoing disadvantages inherent in the known types of distribution and supply chain system now present in the prior art, the present invention provides an improved supply chain management system. As such, the general purpose of the present invention, which will be described subsequently in greater detail, is to provide an improved supply chain management system and method thereof which has all the advantages of the prior art and none of the disadvantages.

It is another object of the present invention to provide an improved supply chain management system comprises: at least one warehouse (101), wherein each warehouse is a centerpiece situated at various strategic point; at least one supplier channel (102), coupled to the at least one warehouse, having a supplier interface; at least one distributor channel (103), coupled to the at least one warehouse, having a distributor interface; a customer interface (104) which also has an optional virtual portal to be used by a customer as a shop page where an entire stock of the products stored in the warehouse is displayed for the customer to select the products from various departments. The storage delivery unit (105) having a built in at least one of a cooler and a fridge to store the selected products by the customer, wherein the storage delivery unit comprises at least one delivery storage trolley for easy storage, and wherein the delivery storage trolley is collapsible trolley and opens like a cupboard with the plurality of shelves, and wherein the products purchased by the customer can be delivered in the storage delivery unit (105) which can be rolled into the storage or kitchen of the customer's house; and an Integrated Accounting software portal (107) interlinked with all the interfaces, wherein all accounts and payments for the customers, distributors, contractors, suppliers, Third parties, and the warehouse are interlinked through the Web-based integrated accounting software portal.

It is another object of the present invention is to provide the improved supply chain management system, wherein one or more warehouses are located in various locations of the cities and in various countries; and wherein each warehouse is automated with robot technology and comprises segregated spaces for various departments for stocking up by various suppliers who bid for spaces through the supplier interface.

It is another object of the present invention is to provide the improved supply chain management system, wherein a supplier interface allows the supplier to bid for the products. to monitor and fill up the stock in the warehouse and Replace the old stock, and wherein the lowest and best bid is awarded by the computer or Quality Assessors.

It is another object of the present invention is to provide the improved supply chain management system, wherein the distributor channels (103) which are automated Mobile Supermarket units, have most products for the particular department contained in it, and are automated to retrieve the products. And to stack up the products from the warehouse. There can be one or more mobile Supermarkets for each postcode. One postcode can have one or several of mobile Supermarkets. One Mobile supermarket can represent one department or combination of departments.

It is another object of the present invention is to provide the improved supply chain management system, wherein the distributer interface is for the distributers, and wherein the distributor is a shop owner and franchisee who delivers the products to the customer according to the postcode of the customer, and wherein the distributor interface displays the whole stock available in the particular distribution unit, displays the a number of items of each product to be delivered to each customer with customers address and guides the distributor to the location of the customer via the Global positioning system. and through the interlinked software it notifies the warehouse about the restocking of items.

It is another object of the present invention is to provide the improved supply chain management system, wherein the distributor is responsible for any maintenance and repair of the distribution channel.

It is another object of the present invention is to provide the improved supply chain management system, wherein the customer interface, distributor interphase, Distributor Robot picker and Robot stacker interphases, warehouse interphase, quality assessor interphase, warehouse pick up Robot and stacker robot interphases, supplier interface, the accounting portal interface are all linked.

It is another object of the present invention is to provide the improved supply chain management system, wherein the customer interface displays details of the products available in the warehouse for purchasing, and wherein the details of each product comprises the pictures of the product, prices, stock, and other product details with dialogue boxes that can be ticked with number of items the customer wants to order instantly.

It is another object of the present invention is to provide the improved supply chain management system, wherein the storage delivery unit (105) is plugged to 120 and/or 240 Volts plug point.

It is another object of the present invention is to provide the improved supply chain management system, wherein the system further comprises at least one Contractor (108) having a contractor portal to manage flow of the products.

It is another object of the present invention is to provide the improved supply chain management system, wherein the system further comprises at least one quality assessor 106 to supervise the quality of the products received from the suppliers and to determine which supplier should be given the right or approval to stock the warehouse.

It is another object of the present invention is to provide the improved supply chain management system, further comprises a returns portal wherein the returns portal is used by the customer for returning the product when not liked by the customer.

It is another object of the present invention is to provide the improved supply chain management system, further comprises a Courier Portal wherein the courier portal is used for sending parcels and documents from one place to another via courier and shuttle.

It is another object of the present invention is to provide the improved supply chain management system, further comprising different admin level portals selected from an admin, an accountant, customers, distributors, warehouses, suppliers, contractors, and third Party, and each having respective IDs.

It is another object of the present invention is to provide the improved supply chain management system, wherein a website of the system displays information comprising at least one of the following: information concerning discounts, coupons and/or incentives available for the plurality of products, and information concerning the products availability at one or more of the warehouses.

It is another object of the present invention is to provide the improved supply chain management system, further comprising an in-store consumer device configured to generate a limited time, authentication code protected coupons, based on the consumer Purchase.

It is another object of the present invention is to provide a method for supply chain management system with an Integrated accounting Software Portal (107) to manage the portal including consumer, distributor, warehouse, supplier, quality assessor, contractor, accounts, third party, and all management portals.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 depicts the overall supply chain model of the present invention.

FIG. 2 depicts the different aspects of overall supply chain model of the present invention as represented in FIG. 1.

FIG. 3 depicts the flow chart of the supply chain portal of the system.

FIG. 4 depicts the flow chart of the warehouse portal of the system.

FIG. 5 depicts the flow chart of the distribution portal of the system.

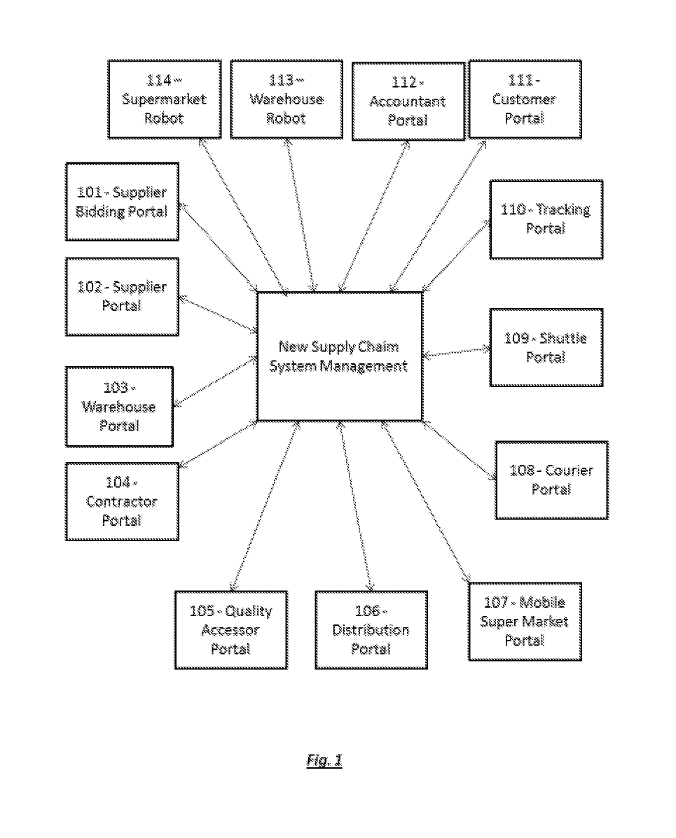

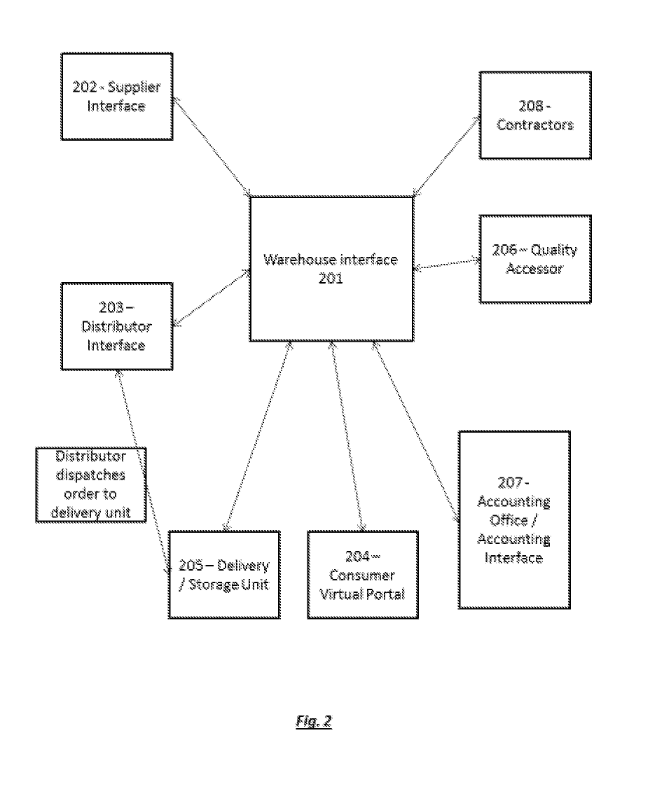

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural and logical changes may be made without departing from the spirit and scope of the present invention. The following detailed description is, therefore, not to be taken in a limiting sense, and the scope of the present invention is defined by the appended claims and their equivalents.

The novel features of the invention are set forth with particularity in the appended claims. A better understanding of the features and advantages of the present invention will be obtained by reference to the following detailed description that sets forth illustrative embodiments, in which the principles of the invention are utilized.

### Embodiment 1

In an exemplary embodiment of the present invention, FIG. 2 depicts the overall supply chain model of the present invention. The supply management system comprises of supplier portal 102; supplier bidding portal 101; warehouse portal 103; contractor portal 104; quality assessor portal 105; distributor/distribution channel portal 106; mobile supermarket 107; courier portal 108; shuttle portal 109; tracking portal 110; accountant portal 112; customer portal 111; warehouse robot portal 113; mobile supermarket robot portal 114; master admin/master CRM portal; mobile friendly mobiles apps for android, ios and windows; and pharmacy portal, optional. The customer portal comprises the dropdown cascade which—is a specially designed Dropdown Menu=One hover over Drop down>Sub drop down>Sub-Sub Drop down>Sub-sub-sub drop down>Sub-sub-sub-sub drop down>Product with picture and price>customer clicks How many>product get to the Basket.—This is a new innovation and is not existent in any prior art.

This is a new concept online Supermarket with Virtual experience with all new concepts which consists of Suppliers, Supplier bidding to sell their products for future dates, Quality assessors, warehouse contractors, warehouse with automated Stacking and Retrieval using Robots to de-palletize, stack, and to retrieve products, Mobile Supermarkets with automated stacking and Retrieval systems which are assigned to for one or more postcodes, Shuttle service, Courier service, [pharmacy service], Highly interactive customer portal with virtual options, etc., with the fastest mode of delivery ever.

Brief description on how each portal is functioning given below:

Supplier Portal

Suppliers will have a supplier interface or portal to monitor the stock and fill up the stock in the warehouse. The integrated software of this whole supermarket system will to manage all the various components at various levels with many interfaces. The suppliers will restock their products in warehouse on a daily basis to 100% stock. The Suppliers can check for their stocks through the Supplier interface.

Supplier Bidding Portal

Each supplier will be bidding for a space in the warehouse for a particular product on a daily basis. Any supplier can register with the warehouse and once approved by the admin to be a registered supplier, they then can bid for each product for each date, week, month or year.—if approved, they will be in charge of supplying and Restocking for the particular product for the period approved.

Warehouse

In this model, warehouse is one of the important aspects. Warehouses will be situated at various strategic places at various cities and in various countries. Each Warehouse will have various supplier channels and distributor Channels. Warehouse is fully automated with robot technology. One set of Robots will be in charge of Retrieving goods from the supplier vehicle, de-pelletizing and stacking to the products to the correct Shelves whereas another set of Robots are involved in of retrieving the stocks for distributors. There will be a separate Automated Courier sorting area.

Specially Designed Warehouse Shelves

Warehouse shelves are specially designed slanted shelves. Another Set of robots are involved in retrieving the products from warehouse shelves and stacking the products to the Dispatch dock or direct to the mobile supermarket, shuttle service, or to courier. Warehouse will have huge pace with Various Departments. Various suppliers/companies will stock up the warehouse after successful bidding. Each department will have spaces for various suppliers. Each supplier will have spaces to display/stack up the spaces. Suppliers will stack up the warehouse on daily or weekly or monthly basis depending on the demand of their products.

Quality Assessor

Quality Assessor is a contractor who will supervise for the quality of the product from the suppliers and determine which supplier will be given the right to stock the warehouse. There can be more than one supplier for different brands of same product. Each brand will be given different brand name [e.g.: Potato can be of several varieties and each variety will be given a brand name and code].

New Concept Distribution Channels

The automated Mobile Supermarkets

The distinctive new concept of this Supply chain model is that—there will be various distribution channels which are automated mobile supermarket units to deliver the goods to customers according to the postcode of the customer. There can be one distribution channel for each postcode or one distribution channel can serve more than one postcode depending on the demand. One Distribution Channel may consist of one or several departments. For example, one distribution channel may sell only groceries and another distribution channel may sell only clothing.

Distribution Channels are automated Mobile Supermarket units

Instead of customers going physically to a supermarket, the supermarket comes to the customer's doorstep. Automated mobile supermarkets are mobile units that will have several products of a supermarket stacked in order in various shelves and may use automated/Robot technology to retrieve the products. When a customer orders a product, the warehouse, the supplier, the mobile supermarket [distributor] that is responsible for the postcode will get the information. The distributor once click on the particular order to be dispatched and click on “Dispatch”, the integrated GPS tracker will direct him to the Dispatch address and the automated system [or robot] in the mobile unit will start retrieving the product and stack it in the bagging area on to a particular “Basket” or Delivery/Storage unit and the Distributor/driver or his assistant will deliver the product to the required address.

Advantage of the Automated Mobile Supermarkets

It saves the large supermarket shopping spaces saving lots of money. Instead of Customers going to the shopping center wasting time, energy, money, using vehicles, fuel, etc., this mobile distribution Channel will go to each house and deliver the product in a an appealing mobile Delivery/Storage unit that can be rolled into the storage or kitchen area of the house. All groceries can be in the same Delivery/Storage unit until used up. This saves a lot of plastic bags.

The mobile delivery/storage unit will have a built in Cooler/Fridge that will work both with 12/24 V DC in any vehicle and can be plugged to 120V/240V AC. This saves the time and energy of unloading and shelving the products. There may be one or more Distribution Channel for each postcode or one Distribution Channel can serve more than one postcode depending on the workload and this can be automatically adjusted on the software. One distribution channel may be used for one or several departments. As soon as the customer orders the products, the warehouse, the distribution Channel [Mobile Supermarket] designated for that post code, the supplier portals, the accounts portal, the admin portal will all reflect these changes. The Distribution Channel [Mobile Supermarket] will automatically and immediately dispatch the orders on the Delivery/Storage unit via automated Robot system and the distributor or his assistant will deliver the products to customer with the Delivery/Storage unit.

Each time a product is sold or delivered to customer it will be all reflected on the Supplier Portal, warehouse Portal, the Robot portals, the Shuttle portals, the Courier portals and distributor portal relevant to the postcode. Accordingly the Supplier will be ready to replace the order and warehouse will be ready to dispatch the goods to the distribution channel to fill the reserve to 100%. Suppliers will fill the warehouse with their designated products once or twice a day. Warehouse will be ready with the products to load to each Distribution Channel [Mobile Supermarket] or the shuttle or Courier via Automated Robots.

Customers will leave the empty delivery/storage unit in front with any returned items and any recycling materials when they order for the next time. When the next ordered stock arrives with another Delivery/Storage unit, previous delivery/storage unit will be taken back to the distributor points/channel. Distributor will be in charge of disposing the recycling material in their bins, clean the delivery/storage unit and send the returned items to the returns area in the warehouse.

As soon as the customer orders the products and clicked the payment the automated system in the distributor point is activated and products are automatically delivered to the delivery trolley/unit. Delivery/Storage unit is a collapsible mobile Storage with collapsible fridge and freezer that can be powered by 12/24V DC or 110/240V AC. The Mobile distributor points/channels go to the customer's residence with the products in Delivery/Storage unit which can be rolled on to the Customer's residences that will mingle with the Kitchen furniture.

In an exemplary embodiment of the present invention, FIG. 2 depicts the overall supply chain model of the present invention. The entire system may be divided into separate functional components. The Warehouse 201 is the centerpiece which will be situated at various strategic points at various Cities in Various countries. Each Warehouse will have various Supplier Channels 202 and Distributor Channels 203. Warehouse is fully automated with Robot technology. Warehouse will have huge space with Various Departments. Various Supplier Companies will stock up the warehouse.

Each Department will have spaces for various Suppliers. Each supplier will have spaces to display/Stack up the spaces. Suppliers will stack up the warehouse on daily or weekly basis depending on the demand. The software interface of the Warehouse will determine how much of each product to stock up. The integrated software calculates the amount depending on the demand [sales] on the previous days and we can add another 25-50% manually depending on the product. For any new product, we arbitrarily add an amount to the warehouse.

The Proprietor of the Warehouse is the franchiser. Another Component is the Supplier Component 202 where suppliers have a Supplier interface to monitor the stock and fill up the Stock in the warehouse. Suppliers will restock their products in warehouse on a daily basis to 100% stock. The Suppliers can check for their stocks through the Supplier interface. Each Supplier will be bidding for a space in the warehouse for a particular product on a daily basis. All orders from the warehouse are automated and show up on the Supplier interface. All designated suppliers will be bidding for the orders and the lowest and best bid is awarded by the computer will automatically program requirements to each Supplier depending on the stock and suppliers will deliver to warehouse. Therefore the Customer Interface and Supplier Interface are also linked. Each Supplier has a Supplier ID. The next Component in the integrated system is the Distributor Interface 203. Here the Distributor is a shop owner and will deliver the Product to the Customer. He will stock the items in his possession by ordering all the products from the warehouse via the Distributor interface on a daily basis. This warehouse will have various Distributors to deliver the goods to customers according to the postcode of the customer. There may be more than one distributor for one postcode or one distributor can serve more than one postcode depending on the workload. Distributors will stock up their shop to 100% everyday through the Distributors interface. Distributor portal or interface will show how many items of each product to be picked up from the warehouse. Warehouse portal will also show how many items of each product to be dispatched to the particular Distributor. Stock amount for each product is calculated according to the demand. As soon as the Distributor presses “Restock button” at the Distributor interface and proceeds to warehouse, the warehouse will start processing the Restock orders for the particular Distributor and also allot a Gate and Dock number for the distributor that will appear on the particular distributor's portal for them to proceed to the particular gate and dock to “Restock” the items. The automated robot arms will deliver the stock to the correct shelves in the Distributor units. The warehouses will instantly checkout the products through Automated Delivery System as soon as the distributer places an order. If the Distributor is too busy with the delivery, he or she may ask for the Shuttle or Courier to deliver the stocked item by clicking “Deliver to me” button on the reorder interphase. Distributors will stock up their shops to 100% each day by ordering and picking up their orders from the Warehouse each day. Distributor or franchisee Payment: Warehouse will pay a commission from the sale to the Distributor [There are options to top up the Distributor if his commission is low due to poor sales in an area]. Distributor is a franchisee and will purchase a Distribution Channel [Automated Mobile Supermarket unit]. Distributor or franchisee Holds 49% and the franchiser hold 51% of the Distribution Channel. Distributors or franchisee are responsible for any maintenance and repair of the Mobile distribution units. There will be monthly servicing charges to maintain the Mobile units and automated systems. Distributor or franchisee will also pay in full the initial payment for all the stocks. Distribution Channels are automated Mobile Supermarket units—with all the products contained in it and is automated to receive goods from warehouse and deliver goods to customer.—Distribution Channels are automated Mobile Supermarket units can be either a modified Purpose built Double Decker Bus, or a large size purpose built Van, Large Purpose built Caravan or a Large Purpose built Trailer with several Shelves. When customer orders any products and the payment sorted, the automated robot inside the mobile supermarket will automatically sort the products into bagging area into the storage/delivery unit. The Mobile supermarket operator drives the Mobile Supermarket to the doorstep of the customer. The operator or his assistant will deliver the products to the Customer on the storage/delivery units. The Automation is done either via a robot picker or via automated shelf doors opening and closing releasing the products to the belt which delivers the products to the bagging area. The Mobile Delivery/storage unit will have a built in Cooler/Fridge that will work both with 12 V DC in any vehicle and can be plugged to 120V/240V AC. Instead of customers going physically to a supermarket, the supermarket comes to the customer's doorstep. Delivery Storage trolley is a new concept: Trolleys are collapsible for easy storage. It opens like a cupboard with several shelves. One of the shelves is collapsible freezer and another shelf is a cooler. Other shelves are for general storage. When it is open, the top surface will be like a table top which will blend with Kitchen Table and form a nice piece of Furniture. All the products can store in the shelves until used up or when ready for another order. This avoids any bagging and shelving needs. It saves the large supermarket Shopping Spaces. Instead of Customers going to the shopping center waiting time, energy, money, using vehicles, fuel, etc., this mobile distribution Channel will go to each house and deliver the product in a an appealing mobile Delivery/Storage unit that can be rolled into the storage or kitchen area of the house. All groceries can be in the storage unit until used up. Warehouse will also have Contractors 208 working to oversee the correct flow of goods. So, there should be a contractor portal to manage them. They will be paid according to the service they render.

Another most important component is the Customer Interface 204 which has special features and also has a virtual Portal for virtual customer experience. On the Virtual customer portal or shop page, there will be several drop down menus as well as icons with doors to get into various departments. There will be several departments on the left side as well as from the drop-down Menus. There will be instant drop-down and large sub-drop-down, sub-sub-sub dropdown, sub-sub-sub-sub dropdown menus that culminates with all the pictures of the products, prices, stock, product details, etc. with dialogue boxes that can be ticked instantly with number of items the customer wants to order. As soon as the product is ticked the number, those products will move into the trolley and it goes to checkout. At the bottom of the dialogue box there will be options to go to different departments, home or checkout.

When the customer moves the cursor on to a department, a large dialogue box will open with all the items in that department. Customer will then tick all the Items needed in that departments. At the bottom of the Dialogue box, there will be options to go to other departments, home, or Checkout. There will be following departments: Vegetables and fruits, Bakery, Sweets and Biscuits, Grocery, Dairy, Drinks, Frozen, Stationery, Cosmetics, Toiletries, Men's Clothing, Ladies clothing, Manchester, Electrical, Electronic, Audio-visual, Baby section, Children section, Sports, Leisure, Gardening, Furniture, Solar, Vehicle, Parts, Taxi, Transport, Courier, Travel, Insurance, Electricity, Gas, Banking, Repairs, Services, Building, Hot and Fresh, etc. Top Drop down Menus will have all the products with different categories. There will be drop down as well as large sub, sub-sub, sub-sub-sub, sub-sub-sub-sub dropdown menus that culminates with all the products with product descriptions, prices, amount of stock available, and dialogue button to enter the number of items. There will be soft music when opening the WEBSITE and we will be able to modify the music from our side. On the Virtual portal each icon is a “Virtual Door” and the icon on the left represents one department. When a customer places the cursor on each department, each department will immediately slide open a large Virtual frame with all the products in that department with picture, prices and dialogue box. Customer can move to various isles by moving the cursor. The customer can add to cart by ticking the product displayed and a dialogue box will appear on the product to enter how many items of the same the customer wants. The dialogue box will be next to or on the picture along with product description. Customer can order more than one item from the same department and the department and the frame would not close until customer has bought his entire item from that department. There will be navigation panel at the bottom of each virtual frame to go to the other departments. It will be the same for each of the departments. All these items the customer ticked will go into the Shopping trolley and checkout immediately. Customer can modify the order at the checkout if necessary. We will be able add more departments in the future from the control panel. Admin will be able to add more items in each department in future from the control panel, if necessary. All stock counts for the Distribution Points/Channel assigned for that postcode will appear on the bottom of each product in small print. There should be a warning for the customers “stock low in count” and displays how many items available when the stock is below 25% in the distributor's stock. Any item if not in stock will come with a dialogue “this item is temporarily out of stock” “Sorry for the inconvenience”. “Would you like to order similar item” or “would you want us to deliver when the item becomes available”. If one Customer, Distributor, Contractor or Supplier introduced new Customer and the new customer enters the ID of the one who introduced them [it could be another Customer, a Distributor, a Contractor or a Supplier] at the time of Joining, the one who introduced will be entitled for Discounts in the future. This will depend on the amount of purchase by the particular Customer. As soon as the customer orders the products, the warehouse, the distribution Chanel designated to that post code, the supplier portals, the accounts portal, the admin portal will all reflect these changes. When customer enters the Virtual Checkout or Payment Portal it will ask for Customer ID [or Member number]. If the customer does not have an ID and come into the portal for the Virtual Checkout or Payment Portal for first time, there will be a prompt to “Register your Details”. Customer will give their details like Country, First Name, Surname, DOB, License ID, address for delivery, postcode, and the ID number of the Customer, distributor, contractor or Supplier who introduced them, etc. The Computer will generate a “Customer ID number”. {e.g.: Country-Australia First Name—XX, Surname—YY, DOB—MM-DD-YY, Additional Identifier [another three Numeral-0002] then Customer ID can be AUS2MOHBAL2009870002}. Warehouse instantly checkout the products as soon as the distributor places an order. The distributor will be assigned the Gate number and to pick the products at the time of Ordering, and the orders will go to the Gate assigned for that Distributor. Distributor will come and pick up their orders instantly from the Warehouse without delay, if the distributor is unable to come to pick the items from the warehouse he can ask for the “Shuttle” or the courier Service to deliver the items at a small cost. There will be a “Product ID” for each Product, which will be a combination of six Alphabet and four Numerals. First three Alphabet of the product will represent the Department [Grocery, Stationery, etc.]. The second three alphabets will represent the Supplier. Customers will be able to purchase an Item and should be able to select a different location for delivery to be sent to their friends or relatives or an organization, if the customer wants the gift to be wrapped in a gift paper to be given to a friend or relative, this can be done at a small cost. The Distributor in that Delivery postcode will be delivering the item and the commission for the sale will go the Distributor who delivered products.

Another Component is the Quality Assessor 206 who is a contractor who will supervise for the quality of the product from the suppliers and determine which supplier will be given the right to stock the warehouse. If any stock found to defective it will be returned to the supplier. There can be more than one supplier for different brands of same product but will be given different brand name [e.g.: Potato can be of several varieties and each variety will be given a brand name and code]. A very important component interlinked with all the interface is the Integrated Accounting Software Portal 207. Same website has a sophisticated accounting software package integrated and will do all accounting needs. All accounts and payments for the Customers, Distributors, Contractors, Suppliers, Third Parties and the warehouse are interlinked through this Web-based integrated Accounting software portal. This integrated software will deal with all accounts, payments, commissions, customer points, from and to for the Suppliers, Distributors, customers, contractors, third party and others. When customer elects to pay Cash on Arrival, warehouse will deduct that amount from the Distributor's account who is assigned for that area. Distributor will then reimburse that amounts from the Customer when he delivers the products, either cash on delivery, Card, EFTPOS, Shopping vouchers, Coupons, our own shopping card. Another payment option is to pay on loan. This is a loan agreement between the distributor and the Customer. Loan will attract a loan processing fee and interest, when customer signs up for a loan. When the customer signs the agreement for loan Payment option, the distributor will tick a box on his orders. When the box is ticked, warehouse will deduct the amount from the distributor. Distributor will be in-charge of reimbursing this loan from the Customer. Distributor will decide if he is happy to give a customer on a loan or not. The Accounting Office representing the warehouses in all areas processes the payments at all levels.

Further aspects of the invention will include Return Portal and Courier Portal. If there is a Return, customer will write a description of why they are returning and sign a declaration. They will place the item in the box provided and leave it at the door. The distributor will pick up the item and deliver to warehouse. Warehouse will send it back to the Supplier. Once the supplier gets the product, warehouse will reimburse it from supplier. Warehouse will then reimburse the money/payment to the Customer or credited to customer's account which can be used by the customer for future transactions. There will be mobile friendly apps and customers should be able to order for the products when they are travelling in their cars, train, bus, or travel anywhere. Customer could select a time frame for Delivery of goods from the Payment Ports. [e.g. between 6-8 pm on Jul. 22, 2026] Distributor will process the order for that date and time. There will be suggestion box for the customers to give their feedbacks. There will be Courier Portal on the customer Website which gives the very cheap prices for sending parcels and documents. The webpage gives the guideline of prices for sizes of the parcel and the weights. When they enter the details of the sender's postcode and address and pay for the parcel, automatically the information is sent to courier service, warehouse, distributor, shuttle portals. Whoever is near the sender's address can click to pick the parcel and proceed to the sender's address guided by the GPS. The label is also created automatically either in the courier, shuttle or distributor channel responsible for the pick up. Parcels are delivered to sorting are in the warehouse in the sorting area. There will be an extensive customer Database with their emails and we should be able to send all promotional items, etc. on weekly basis. There will be a registration panel for registration of Customers, Distributors, Suppliers, contractors, Third party, etc. When a customer first buys any product [or contact the Shop] all the contact details are stored and a “Customer ID number” is created once they make their payments. The Customer will use the same “Customer ID number” for future purchases. This “Customer ID number” will link them to all their accounts. “Customer ID number” will generate “Customer points” depending on Purchase. Every Purchase of one dollar will attract 5 customer points (TBD) 2000 Customer points [$200.00 Purchase] will attract between 2-20 dollars (TBD). Customer can use to redeem the “Customer points” to get a discount on their purchases or transfer their “Customer points” to some “Third Party” Entities like flights, Accommodation, Charities, Schools or help to buy Coupons or Gift Cards. There will be a space in each product picture—Product ID, Actual price, price Comparison of the product, and how many customer points to purchase it. They can either redeem their points at the purchase of each product or they can redeem their “Customer points” at the checkout. The checkout should have a space showing their “Customer Points” and there will be a space to redeem their points. Customer should be able to transfer them to third parties even. Customers will be able to purchase an Item and should be able to select a different location for delivery to be sent to their friends or relatives or an organization. The Distributor in that Delivery postcode will be delivering the item and the commission for the sale will go the Distributor who delivered products.

Furthermore, There will be different admin level portals for: Admin [Each Admin will have a Admin ID]; Accountant [Each Accountant will have a Accountant ID]; Customers [Each Customer will have a Customer ID]; Distributors [Each Distributor will have a Distributor ID depending on their Post code]; Warehouse [Each Warehouse will have a Warehouse ID depending on Country and City]; Suppliers [Each Supplier will have supplier ID.]; Contractors [Each Contractor will have a Contractor ID] AND Third Party [Each Third Party will have a Third Party ID].

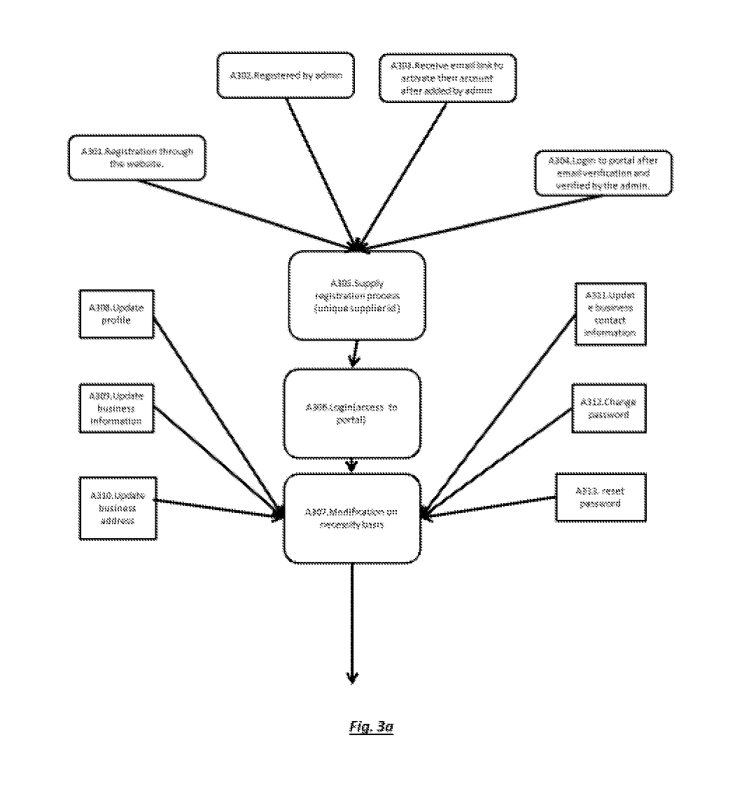

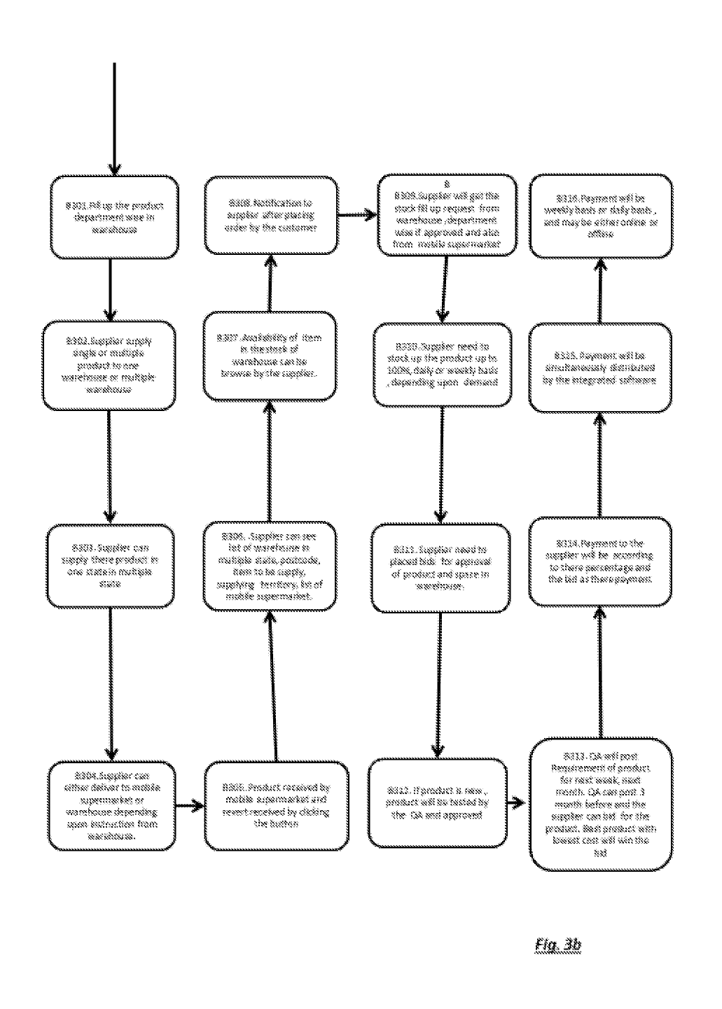

In an exemplary embodiment, FIG. 3 depicts the flow chart of the supply chain portal of the system. In the present invention supplier plays a major role to provide goods to the customer through warehouse. Following are the process that describes the whole system of the supplier in the current invention. Block A301, Supplier can make self-registration through the website. Block A302, Supplier can be registered by admin. Block A303, Supplier will receive email link to activate their account whenever they are added by the Admin. Block A304, Supplier can login specific portal if supplier account is email verified and admin verified. Block A305, Registration process completed, unique ID is given to each supplier. There will be 2 step or 3 step verification via SMS and via other ways to enter supplier portal, to avoid any hackers. Block A306, supplier can now login to the portal can access the portal. Block A307, supplier can modify their account if necessary. Block A308, Supplier can update individual profile information. Block A309, Supplier can update individual business information. Block A310, Supplier can update individual business address. Block A311, supplier can update individual business contact information. Block A312, Supplier can change, reset password to secure personal account and if supplier forgot the password Block A313. Block B301, Supplier can stock up products to warehouse department wise. Block B302, One Supplier can supply to one warehouse or multiple warehouse in various territories. There can be one or more warehouses for each state, and also they can supply one product or multiple products. Block B303, any supplier can supply to the warehouse on their or any territory. Same supplier can supply to the warehouse in Sydney and also the warehouse in Melbourne either same product or different product in different products in each warehouse. Block B304, there will be an option for Supplier supplying directly to the mobile supermarket of various postcodes bypassing warehouse. In that case, there will be an entry on the warehouse as that quantity being delivered to warehouse by the Supplier and warehouse supplying the products to the particular supermarket - for accounting purposes. There will be an option on the warehouse portal instructing Supplier to Supply directly to various Mobile supermarkets with quantities to be supplied to each mobile supermarket. Supplier stocks up either warehouse or directly deliver to mobile supermarket. Block B305, once the products are delivered and taken by the mobile supermarket, the supermarket owner will tick the button as received in full for those particular items. Block B306, Suppliers can see list of warehouse in various Territories. Supplier can see list of warehouses and mobile supermarkets (which are assigned for each warehouse) with the list of items they need to replace under their serving territories. Supplier can see list of warehouse in various states and countries. Supplier can see list of warehouses and mobile supermarkets (which are assigned for each warehouse) with the list of items they need to replace under their serving territories. Block B307, Suppliers can see stock to Refill for each warehouses department wise and will stock the items on daily basis when approved by the warehouse. Block B308, Supplier will be able to see the stock deficit for each item and will be able to view the deficit in a dynamic way for each purchase by customer under those postcodes. Supplier portal is dynamic like all other ports and when a transaction happens i.e.; when a customer buys a product (e.g.: 1Kg Sugar) and the product is delivered to the customer (e.g.: 1Kg Sugar) , the mobile supermarket will show one product (e.g.: 1Kg Sugar) less in their stock , the warehouse will show one product (e.g.: 1Kg Sugar) less and the supplier portal will show one product to be stocked up. (e.g.: 1Kg Sugar), all at the same time. Supplier will be able to see the stock need of the warehouse on the supplier portal and also will get notification about how much to supply from the quality assessor portal as well. Supplier who has won the Contract to supply particular product will see the product to supply in large letters boxed. Supplier will also be notified for each order placed by customer under those postcodes. Supplier can view the items which are required by warehouse. Block B309, Supplier can also see the stock fill up request from warehouse department wise. Block B310, Everyday supplier needs to stock up the products up to 100% for the approved product on a daily or weekly basis depending on the demand. Block B311, the registered suppliers can see the stock demands on their supplier portal and can submit individual bid for other products as well. Whoever gives the lowest bid and submit sample to quality assessors, quality assessors after checking the quality of the products, can approve the product. Supplier will submit quality pictures, short explanation of the products, upload any audios or videos if necessary about the product, any instructions of how to use, any user manual, etc.—via the supplier portal. Block B312, Supplier will have access to introduce a new item via supplier portal. If a product supplier thinks might be selling good, he can submit for approval of a new product by submitting quality pictures, short explanation of the products, any videos if necessary about the product, any instructions of how to use, any user manual, etc.—via the supplier portal- under “Introducing New Product”—and submitting a samples.—Quality assessors will analyze the product and if happy, they can approve the product and upload the product on the warehouse portal which will be automatically reflected on the mobile supermarket, and on Customer portal. Supplier will have to bid for the product and whoever submits the lowest quotation with the best quality will be given the chance to stock up the product—Supplier will be paid as the product gets sold. Supplier can bid for products as well. Block B313, Quality assessors will be posting the requirements for each product for the weeks or months ahead on the quality assessor's portal, which will be reflected on the supplier Portal. They can post the requirements for the month or 3 months ahead. The requirements can be tabulated on a calendar for the week and month Any supplier can bid for the product for the week ahead or even a month or 3 ahead along with the their lowest prices, and upload quality photos, clear written description, any audio or videos about the product, and clearly enter the sample number on the space provided. Sample number will be a combination of few letters of the Product/week number/year/Supplier/followed by 4 numerals. They will also post or hand over the sample clearly labelled with the sample number. Quality assessor responsible for that particular department will analyse the sample and approve or reject the sample. If rejecting the sample he can put the reason—e.g.: sample not good, price dearer. If the price is dearer, if the supplier things he can supply for a cheaper price, he may choose to resubmit. QA will the submissions and check the sample with the number provided. Block B314, Supplier will receive the payments from Warehouse through Our Accounting System. All the accounts are integrated. Any product sold, the mobile supermarket will get its percentage as determined by the Admin, and the warehouse will get its percentage as determined by the Admin. Block B315, Supplier will get the money for the amount he bid all done simultaneously by the integrated accounting software. Block B316, all the accounts can either be paid online simultaneously or the total amount can be paid at the end of the week.

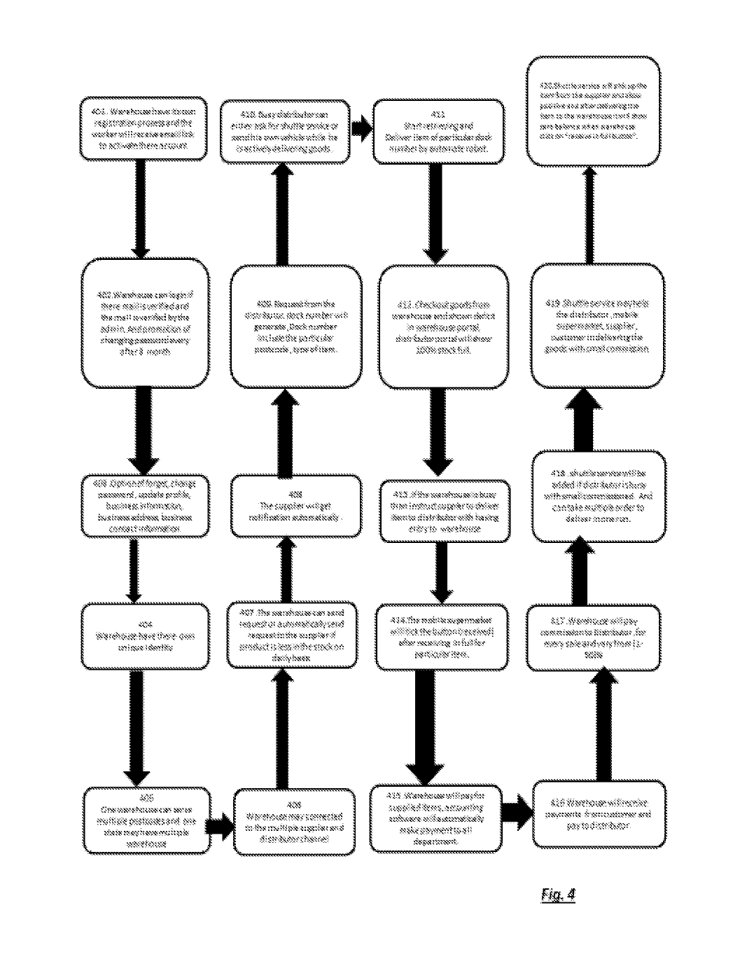

In an exemplary embodiment, FIG. 4 depicts the flow chart of the warehouse portal of the system. In the present invention warehouse act as centerpiece or heart of the system, main component and function are illustrate here as follows. Block 401, Warehouse will have its own registration process. Warehouse workers will receive email link to activate their account whenever they are added by a Warehouse Admin. Block 402, Warehouse can login if their account is email verified and admin verified. There will be 2 step or 3 step verification for all log in—with SMS and other ways, to avoid any hackers. There will be a prompt every 3 months to reset their passwords for more safety. Block 403, Warehouse can have the forget password option. Warehouse can update his profile information. Warehouse can update his business information. Warehouse can update his business address. Warehouse can update his business contact information. Warehouse can change his password. Block 404, Warehouse can have a unique id to get identified easily. Block 405, Warehouse can serve one or more Australian postcodes. One warehouse will serve several postcodes in a state and in one state, there can be one or more warehouses. Block 406, Warehouse can be connected with multiple Supplier channel, and warehouse can be connected with multiple Distributor channel. Block 407, Warehouse can send request to supplier to fill up the stock, the associated supplier will be automatically notified to stock up the products for each department. Warehouse will automatically send request to supplier to fill up the stock on daily basis or whenever a product will be less in stock. Block 408, the associated supplier will be automatically notified to stock up the products for each department. Block 409, Warehouse can have the restock item request from distributor with a Dock Number. And the system will immediately process the checkout of goods to that dock number of distributor from the available stock. The distributor can press restock button in the Distributor portal and the Distributor portal for the particular post code and the warehouse portal will show what items to be restocked to that particular distributor portal of the postcode and advise the Distributor portal with a Dock Number to collect the restock items. Block 410, if Distributor is busy, he or she can ask the shuttle service to restock the item for them. In this case warehouse will deliver the goods to shuttle service and shuttle service will deliver the goods to the Distributor portal. Distributor can also send his own van to pick up goods from the warehouse while he is actively delivering goods. Block 411, The Automated robots will start retrieving the products to restock items required by distributor and deliver to the particular Dock Number. The Automated system will immediately process the checkout of goods to that dock number of distributor from the available stock. Distributor will drive the mobile supermarket to the particular Dock number and restock the items. Block 412, As soon as the stocks are delivered to the Distributor portal and the distributor has ticked each item on the computer as received, the distributor portal will show all stock to 100% and warehouse portal will show those items as deficit. The supplier portal will show how much each item is needed to restocked after each delivery. Block 413, If the warehouse is too busy to handle good directly, warehouse can request the supplier to transfer the items directly to the distributor mobile supermarkets in various postcodes. If the supplier supplies directly to mobile supermarket, there will still have to be an entry on the warehouse as that quantity of each product being delivered directly to each distributor mobile supermarket on behalf of the warehouse by the Supplier—for accounting purposes. There will be a click option on the warehouse portal orders instructing Supplier to Supply directly to various Mobile supermarkets linked to the warehouse with quantities to be supplied to each mobile supermarkets. Block 414, once the products are delivered and taken by the mobile supermarket, the supermarket owner will tick the button as received in full for those particular items. These entries will be reflected on the warehouse as items received by warehouse and delivered to mobile supermarkets for accounting purposes. Block 415, Warehouse will pay the supplier for the supplied items. The integrated Accounting Software automatically calculates and makes the payments to warehouse, distributor, Supplier, quality assessors, contractors, etc. The integrated accounting software will automatically generate electronic invoices, bills, etc. and email to the customers, Distributors and suppliers, third parties, etc. Block 416, Warehouse will also receive payments from the customer and pay a commission to Distributor for distributing the items to the customers. Warehouse is the main Centre of all activities. When the customer orders a product and pays for it, all the payments goes to the warehouse account. Distributor gets a percentage of the sale as commission. If the customer elects to pay cash on delivery [COD] or pay by card or by other methods, warehouse will deduct the amount from the distributor in-charge of delivering the products. Distributor will then collect the money from the customer on delivering the goods. Distributor can only sell the products from the warehouse items and not allowed to sell anything else. Block 417, Warehouse will pay commission to Distributor for every sale. Commission for each product can be set by warehouse. The commission can vary from 1-50%. Block 418, Warehouse will maintain the Shuttle service channels so that it can help Mobile Supermarkets, Suppliers as well customers. If the mobile supermarket distributor channel is busy with delivering the goods to customers and the stocked items are low and need to be restocked urgently, the mobile supermarket distributor channel can ask the warehouse to restock items via shuttle at a small commission to the distributor. One shuttle can take multiple orders for various mobile supermarkets in one go and will deliver to various mobile supermarkets in one run. Block 419, if the supplier needs transport for the goods, again shuttle service can pick them at a cost. If the shuttle service picked up the restock items on behalf of a particular mobile supermarket, the warehouse entry will show delivered to shuttle - particular number of products; On the shuttle portal of the particular shuttle number it will show as received from warehouse on behalf the mobile supermarket for particular post code. When the shuttle delivered the goods to the particular mobile supermarket and checked correct by the distributor, the distributor will then press the button on the Distributor portal as Received in Full. Once the distributor clicks the button, automatically, shuttle portal will show Delivered in full to the particular Mobile Supermarket. This will automatically reflected on the warehouse portal. Also, distributor channel may request extra help with delivering goods on time and the Shuttle Service can help delivering the goods at a small commission to the distributor. Block 420, if the shuttle need to pick up products from the supplier, again once the products are counted and taken—the shuttle portal will show positive as to the amount of goods in possession. Once the Shuttle delivers the products to warehouse, shuttle portal will show zero balance once the warehouse portal clicks the button “Received in full”.

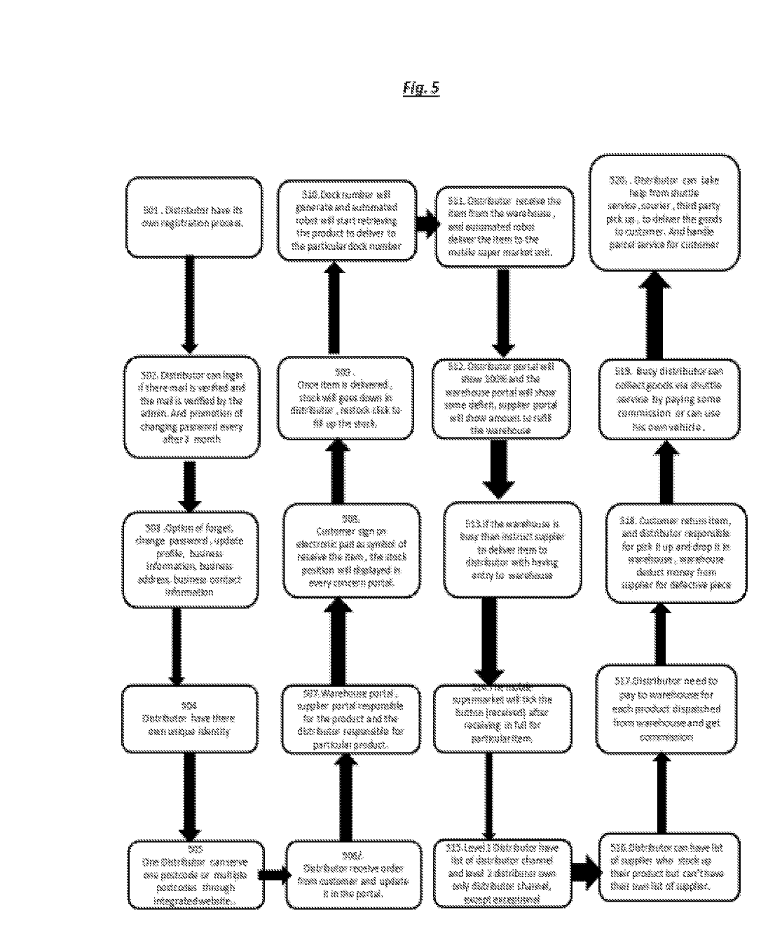

In an exemplary embodiment, FIG. 5 depicts the flow chart of the distribution portal of the system. According to the present invention distributor main function is to distribute the goods, which is discussing as follows. Block 501, Distributor will have its own registration process. Block 502, Distributor can login if their account is email verified and admin verified. There will be a prompt every 3 months to reset their passwords for more safety. Block 203, Distributor can have the forget password option. Distributor can update his profile information. Distributor can update his business information. Distributor can update his business address. Distributor can update his business contact information. Distributor can change his password. There will be 2 step or 3 step verification for all log in—with SMS and other ways, to avoid any hackers. Block 504, Distributor can have a unique id to get identified easily. Block 505, one distributor can serve single or more postcodes. Block 506, Distributor can receive orders from customers through the integrated website. After receiving order distributor will dispatch the order through their distributor channel. Block 507, when the customer orders a product, the warehouse Portal, the Supplier Portal responsible for the product, and the Distributor responsible for that particular postcode will get the orders. Block 508, When the distributor delivers the goods and the customer signs on the electronic pad accepting they received the goods in full, the stock position will be reflected in the Distributor Portal, warehouse portal and supplier portal as well. Block 509, once orders delivered, and the stock count goes down, distributor can click on Restock Items. A Dock Number will be allocated through which Warehouse will stock up the distributor. Distributor can determine a time suitable for restocking the items. Once the distributor press restock button in the Distributor portal and the Distributor portal for the particular post code and the warehouse portal will show what items to be restocked to that particular distributor portal of the postcode and advise the Distributor portal with a Dock Number to collect the restock items. Block 510, The Automated robots will start retrieving the products to restock items required by distributor and deliver to the particular Dock Number. The Automated system will immediately process the checkout of goods to that dock number of distributor from the available stock. Block 511, Distributor will drive the mobile supermarket to the particular Dock number and restock the items. Block 512, As soon as the stocks are delivered to the Distributor portal and the distributor has ticked each item on the computer as received, the distributor portal will show all stock to 100% and warehouse portal will show those items as deficit. The supplier portal will show how much each item is needed to restocked after each delivery. Block 513, if the warehouse is too busy to handle good directly, warehouse can request the supplier to transfer the items directly to the distributor mobile supermarkets in various postcodes. If the supplier supplies directly to mobile supermarket, there will still have to be an entry on the warehouse as that quantity of each product being delivered directly to each distributor mobile supermarket on behalf of the warehouse by the Supplier—for accounting purposes. There will be an option on the warehouse portal orders instructing Supplier to Supply directly to various Mobile supermarkets linked to the warehouse with quantities to be supplied to each mobile supermarkets. Block 514, once the products are delivered and taken by the mobile supermarket, the supermarket owner will tick the button as received in full for those particular items. These entries will be reflected on the warehouse as items received by warehouse and delivered to mobile supermarkets via Supplier for accounting purposes. Warehouse will still get its commission for the delivery by the supplier. Block 515 Distributor can have list of Distributor channels associated with them who will deliver the order to customer doorstep. One distributor can own one distributor channel. Exceptionally he can own 2 or more distributor channel. Each distributor channel will have separate distributor portal. Block 516, Distributor can have list of Supplier who can stock up their department space with products. Distributor cannot have their individual list of Suppliers. All supplies to the distributors will have to come from the warehouse, who can stock up their department space with products. Block 517 Distributor needs to pay for each order dispatching from Warehouse to Distributor. Distributor will get a commission from warehouse for each order they serve. Block 518, Distributor can also have return product list from customer through their distributor channel. When there is a return, customer enters the details on the return portal. Depending on the Postcode of the customer, the distributor responsible for the postcode will get return pick up order. The distributor will then pick up the order and return it to the warehouse returns area. Warehouse will deliver the goods back to supplier and deducts the money automatically from the supplier for the defective goods. Block 519, Distributor can deliver Items with Shuttle Services as well “Collect via Shuttle”. If the distributor is too busy with the home delivery and the stock needs to be replaced, he can opt for pressing “Restock Items” and press “Collect via Shuttle”. “Collect via Shuttle” will attract a small commission from the Distributor channel. The distributors on the other hand use own van to collect the Restock items from the warehouse. Block 520, Then Shuttle service will deliver the goods to Mobile distributor unit. The Distributor can ask the “Courier” to deliver the “Restock Items” to the Distributor channel. The distributor also can use a third party to deliver the goods. Distributor Channel will also handle the parcel service for Customer.

Supplier Bidding Portal

In the current invention there will be a bidding portal is available inside supplier portal. All products of the Supermarket will be there on the supplier bidding portal. Any Supplier once approved, can bid for the products. There will be fixed date for each bidding to be held in particular week or month. Only the supplier who won the bid will have the authority to supply for the specified product for the specified period of time.

Contractor Portal

In the present invention there is a portal called contractor portal inside the warehouse portal. Warehouse can add single Contractor or multiple contractors and manage their activity. Contractor will be an employee contracted by Warehouses. Contractors are the contract workers assigned by the warehouse to see the smooth running of the warehouse. Contractor will have their own login. Contractor will receive email and email link to activate their account whenever they will be added to a Warehouse. There will be a prompt every 3 months to reset their passwords for more safety. Contractor will check the flow of Goods for the assigned Warehouse only. Contractor will be Paid Service Provider for a Warehouse. Contractor will receive a contract fee for service by warehouse. Contractor will be added and associated by Warehouses.

Quality Assessor Portal

According to the present invention QA assessor portal plays a major role in examining all the process in supply management system. Following are the process how QA works inside the supply chain system. Login of the QA and it can be done if the account is email verified and admin verified. There will be 2 step or 3 step verification for all log in—with SMS and other ways, to avoid any hackers. There will be a prompt every 3 months to reset their passwords for more safety. QA can be added by admin only and will be given a unique id. QA portal have “forget password” option, can update his profile information. QA should be able change his account password. QA will decide which supplier will supply the particular item to stock the warehouse or warehouses. The registered suppliers can see the stock to be replaced or stock required in the future on their supplier portal and can submit their bid for any products. Whoever gives the lowest bid and submit sample to quality assessors. Quality assessors after checking the quality of the product can approve the product. Supplier will submit quality pictures, short explanation of the products, upload any audio or videos if necessary about the product, any instructions of how to use, any user manual, etc.—via the supplier portal. Supplier will have access to introduce a new item via supplier portal. If a product supplier thinks might be selling good, he can submit for approval of a new product by submitting quality pictures, short explanation of the products, any videos if necessary about the product, any instructions of how to use, any user manual, etc.—via the supplier portal—under introducing New Product, and submitting a samples.—Quality assessors will analyze the product and if happy, they can approve the product and upload the product on the warehouse portal which will be automatically reflected on the mobile supermarket, and on Customer portal. QA's main duty is to check the quality of each product from supplier. They can do all the various scientific testing to determine if the product is of good quality and make sure all the samples and the supplied products all matches. Once they are happy with the products, they can approve the supplier to supply for the week they submitted and they will upload the website with the approved product with all the necessary details for the week it was approved for. Supplier will be in- charge of supplying those products on time, so that quality assessors can check the supply if that matches with the sample and will approve the sample. QA will also receive the feedback from warehouse, customers and Mobile Supermarket for any product. QA will receive all the feedback from warehouse, customers and mobile distributor units for all products and services and will inform Super admin to improve the standards. Quality assessors will be posting the requirements for each product for the week ahead on the quality assessor's portal which will be reflected on the supplier Portal. They can post the requirements for the month or 3 months ahead. The requirements can be tabulated on a calendar for the week and month Any supplier can bid for the product for the week ahead or even a month or 3 ahead along with the their lowest prices, and upload quality photos, clear written description, any audio or videos about the product, and clearly enter the sample number on the space provided. Sample number will be a combination of few letters of the Product/week number/year/Supplier/followed by 4 numerals. They will also post or hand over the sample clearly labeled with the sample number. Quality assessor responsible for that particular department will analyze the sample and approve or reject the sample. If rejecting the sample he can put the reason—e.g. sample not good, price dearer. If the price is dearer, if the supplier things he can supply for a cheaper price, he may choose to resubmit and same testing and rechecking will be done by the QA.

Shuttle Portal

Shuttle Service in the present invention belongs to Warehouse or it can be franchised. Here shuttle Portal will be like the distributor channel Portal. If the Shuttle service is contracted, the shuttle gets a small percentage of off the payments to Distribution channel. Warehouse also can add a Shuttle service. Any of the process like supplier, distributor, customer, etc. can register for Shuttle service. Once they register, they can access the shuttle Portal. Shuttle Service will receive email link to activate their account whenever they are added by the Admin. Shuttle Service can login to his portal if his account is email verified and admin verified. Shuttle Service can have “forgotten password” option in login portal and also can access his portal after login. There will be 2 step or 3 step verification via SMS and via other ways to enter supplier portal, to avoid any hackers. There will be a prompt every 3 months to reset their passwords for more safety. Shuttle Service can serve to one or more than one Australian postcodes.—Shuttle Service is not bound by the postcode. One Shuttle Service can be part of one warehouse. There can be one or more warehouses for each state. Each Shuttle Service will have his own Shuttle Service id which will be unique. Shuttle Service can update his profile information, business information, business address and business contact information. Shuttle Service can change his password. Shuttle Service will be in-charge of taking the Restock items from the warehouse to the mobile supermarket. One Shuttle service can take the restock items from for more than one Mobile Supermarket. When Distributor press “Collect via Shuttle”, warehouse will collect the restock items. Once the orders are collected and ready to go, warehouse will press click the button “Shuttle Pick up” on the website and the available Shuttle will come pick up the Restock items. Any shuttle can answer the need and move to the place requested. Whenever shuttle receives the items to be delivered, the person with the shuttle portal can click a button to say he or she can deliver the items. Warehouse portal will select the first come best served basis. Warehouse will allot a dock number. Shuttle service will then move to the particular dock number. Warehouse will deduct the money from the Shuttle service engaged equivalent to the product prices. Once they deliver the items to a particular mobile supermarket. The distributor will count and takes the items to the mobile supermarket units and put tick against each product ordered for. Once all the ticks done against each product, the money deducted from the shuttle service engaged will be refunded back. The stock that was shown in that particular shuttle service will go to Zero again. The shuttle service will get a small percentage of the worth of goods for shuttling goods. Any shuttle can answer the need by the mobile supermarket by clicking a button in the apps and go to the particular Supermarket and Deliver that shuttle product to customer door step. A small percentage is taken off the commission from the distributor for that stock being delivered by shuttle. If the mobile supermarket is busy and find it hard to deliver goods to customers on time, they can call for the shuttle service. Any shuttle registered can click for the service and come to the mobile supermarket. Here the shuttle will pick up the goods and deliver to the customers. As soon as the shuttle picks up the goods, money equivalent to the price of the goods will be deducted from the Shuttle account. When the customer puts the ticks on the various items as received on the electronic delivery document and signs on the Delivery document, the money is refunded back to the Shuttle service engaged. The Shuttle Service will act as Courier Service during other times.

Courier Portal

In the present system, there will be a separate Courier Portal on the customer website with sizes and weights of the parcel and the prices. When the customer enters the details like postcode and address and pay for the parcel, automatically the label is created in the Distribution Channel in charge for that postcode. There will be a sorting area in the Warehouse. There will be a separate web portal for the parcel delivery service to support delivery of the goods. Warehouse will be the central point and mobile distributor will pick up the parcels and deliver to the sorting center of the warehouse. Sorting center will send to the correct postcode and the distributor of the postcode will deliver the goods to the correct address, so there will be a Portal for parcels pick up, tracking and delivery. When someone orders a pickup from a particular postcode, that delivery unit, courier or the shuttle responsible for that particular postcode will get the notification and pick up the parcel. The parcel will be delivered to the sorting area of the warehouse. The Robots in the Sorting area will sort the parcels. The parcels are delivered to the shuttle service to deliver correct mobile supermarket units or directly deliver the parcels to the customer. Any long distance parcels are sent to the airport via shuttle to be picked up by the shuttle and delivered to the sorting area of the warehouse on the other end. This will then be delivered to the customer by the mobile supermarkets or shuttle units directly.

Tracking Portal

According to the present invention the mobile super market and shuttle services will have GPS Tracking devices. When a customer places an order, the mobile supermarket receives the order. The order gets processed immediately by the robot. The Tracking portal in the Mobile

Supermarket will show the directions for the delivery of goods. The customers can Check how far away are their delivery of goods. The Shuttle portal will have the tracking Portal—to pick up and deliver products from warehouse to the Mobile supermarket. Courier portal will have the Tracking Portal to pick up and deliver parcels.

Accountant Portal

In the present invention all of the accounting, taxation, etc. are done automatically by the integrated accounting software. For overall checking and auditing, there will be a few accountants and auditors checking, overall activities of the entire system. Each Accountant and auditor will have a separate id and password to log in. Accountants will have their own registration process. Accountants can login if their account is email verified and admin verified. Accountants can have the “forget password” option. Accountants can update his profile information, business information, business address, business contact information. Accountants can change his password. —There will be 2 step or 3 step verification for all log in—with SMS and other ways, to avoid any hackers. There will be a prompt every 3 months to reset their passwords for more safety. Accountants can have a unique id to get identified easily. Accountants and Auditors will have access to all accounts related all transactions. At the termination of the Contract Super-Admin can erase an account of a Supplier, Distributor, Courier or Shuttle Service and offer a new ID to a new

Supplier, Distributor, Courier or Shuttle Service.

Pharmacy Portal

In the present invention pharmacy portal will be a separate page in the same website or can be a separate webpage where the customers can order various prescription and non-prescription medications, over the counter medications, etc. There will be a separate pharmacist's Portal where pharmacist can check the scanned prescription and the item to be dispensed. There will be a separate Pharmacist Portal. Customer will be able to order the medicine on line via this portal. They can order over the counter medical products online, for prescription medications doctor or the Secretary in the doctor's office will be able to upload the electronic prescription to the online pharmacy using patient's ID or send it to patient's email. Patient can also go the Pharmacy section on the website and order for the prescription by scanning the prescription. There will be a button to click “please scan your prescription” when the button is hit, it will automatically trigger the connected scanner. There will be another button to upload the prescription. When the prescription is scanned the Robot Dispenser in the Pharmacy department in the warehouse is activated. Once the customer pays the product, the Robot dispenser will automatically dispense the medicine and label the product by automatically reading the QR or bar code of the scanned prescription as well as the prescription sent electronically. There will be an option to for customer to tick if they want the exact brand or they will accept brand substitution. The prices will show up online and they can choose which one suits their budget. The Pharmacist on duty will supervise the correct dispensing of the product via “Pharmacist Portal”. The pharmacy portal will display the prescription on one side and the display the medication to be dispensed on the other. When the pharmacist clicks “Verified” then only the medication will be dispensed. On making the order customer will have the option to write their comments and queries in the interactive comments box portal or they can press talk and a pharmacist can answer their queries. As soon as the prescription is scanned by the doctor or the secretary, the product will be on the check out on the patient's account. As soon as the Patient pay for the medicine and the mobile pharmacy or the mobile distribution unit will deliver the product to the customer.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

What is claimed is:

I claim the following:

1. An improved supply chain management system comprises:
A supplier portal 101;
A supplier bidding portal 102;
A warehouse portal 103;
A contractor portal 104;
A quality accessor portal 105;
A distribution portal 106;
A Mobile Supermarket
A mobile supermarket portal 107;
A courier portal 108;
A shuttle portal 109;
A tracking portal 110;
An accountant portal 112;
A customer portal 111;
A warehouse robot portal 113;
A mobile supermarket robot portal 114;
Customer Points Portal; 115 and
A master-admin portal.

2. The improved supply chain management system according to claim 1, wherein the supplier portal 101 a supplier interface or portal to monitor the stock and fill up the stock in the warehouse.

3. The improved supply chain management system according to claim 1, wherein the supplier portal 101 is configured to restock their products in warehouse on a daily basis to 100% stock.

4. The improved supply chain management system according to claim 1, wherein the supplier bidding portal 102 is configured to monitor the stock and fill up the stock in the warehouse by bidding for orders paced by the customer, and wherein the lowest and best bid is awarded by the computer.

5. The improved supply chain management system according to claim 1, wherein the warehouse portal 103 is configured to manage a plurality of warehouses, wherein one or more warehouses are located in various locations of the cities and the countries; and wherein each warehouse is automated with robot technology and comprises segregated spaces for various departments for stocking up by various suppliers who bid for spaces through the supplier interface.

6. The improved supply chain management system according to claim 1, wherein the contractor portal 104 is configured to manage flow of the products.

7. The improved supply chain management system according to claim 1, wherein the quality assessor portal 105 is configured to supervise the quality of the products received from the suppliers and to determine which supplier should be given the right to stock the warehouse.

8. The improved supply chain management system according to claim 1, wherein the mobile supermarket portal 107 is configured to deliver the goods to customers according to the postcode of the customer.

9. The improved supply chain management system according to claim 1, wherein the shuttle portal 109 is configured to provide transportation facilities to all members of the system.

10. The improved supply chain management system according to claim 1, wherein the tracking portal 110 is configured to track location of the customers, shuttle, courier, distributors, and other members of the system.

11. The improved supply chain management system according to claim 1, wherein the customer portal 111 is configured to display details of the products available in the warehouse for purchasing, and wherein the details of each product comprises the pictures of the product, prices, stock, and other product details with dialogue boxes that can be ticked with number of items the customer wants to order instantly.

12. The improved supply chain management system according to claim 1, wherein the warehouse robot portal 113 is configured to control the automated robot of the warehouse.

13. An improved supply chain management system comprises:
at least one warehouse 201, wherein each warehouse is a centerpiece situated at any strategic point;
at least one supplier channel 202, coupled to the at least one warehouse, having a supplier interface;
at least one distributor channel 203, coupled to the at least one warehouse, having a distributor interface;
a customer interface 204 which is a virtual portal to be used by a customer as a shop page where an entire stock of the products stored in the warehouse is displayed for the customer to select the products in a dropdown cascade;
a storage delivery unit 205 having a built in at least one of a cooler and a fridge to store the selected products by the customer, wherein the storage delivery unit comprises at least one delivery storage trolley for easy storage, and wherein the delivery storage trolley is collapsible trolley and opens like a cupboard with the plurality of shelves, and wherein the products purchased by the customer can be delivered in the storage delivery unit (205) which can be rolled into the storage or kitchen of the customer's house; and
an Integrated Accounting Software Portal 207 interlinked with all the interfaces, wherein all accounts and payments for the Customers, Distributors, Contractors, Suppliers, Third Parties, and the warehouse are interlinked through the Web-based integrated Accounting software portal.

14. The improved supply chain management system as claimed in claim 13, wherein one or more warehouses are located in various locations of the cities and the countries; and wherein each warehouse is automated with robot technology and comprises segregated spaces for various departments for stocking up by various suppliers who bid for spaces through the supplier interface.

15. The improved supply chain management system as claimed in claim 13, wherein a supplier interface is to monitor the stock and fill up the stock in the warehouse by bidding for orders paced by the customer, and wherein the lowest and best bid is awarded by the computer.

16. The improved supply chain management system as claimed in claim 13, wherein the distributor channels (103) which are automated Mobile Supermarket units, have all the products contained in it, and are automated to receive the products from the warehouse.

17. The improved supply chain management system as claimed in claim 13, wherein the distributer interface is for the distributers, and wherein the distributor is a shop owner and delivers the products to the customer according to the postcode of the customer, and wherein the distributor interface displays a number of items of each product to be picked up from the warehouse.

18. The improved supply chain management system as claimed in claim 17, Wherein the distributor is responsible for any maintenance and repair of the distribution channel.

19. The improved supply chain management system as claimed in claim 13, wherein the customer interface and the supplier interface are linked.

20. The improved supply chain management system as claimed in claim 13, wherein the customer interface displays details of the products available in the warehouse for purchasing, and wherein the details of each product comprises the pictures of the product, prices, stock, and other product details with dialogue boxes that can be ticked with number of items the customer wants to order instantly.

21. The improved supply chain management system as claimed in claim 13, wherein the storage delivery unit 205 is plugged to 120 and/or 240 Volts plug point.

22. The improved supply chain management system as claimed in claim 13, wherein the system further comprises at least one Contractor 108 having a contractor portal to manage flow of the products.

23. The improved supply chain management system as claimed in claim 13, wherein the system further comprises a quality assessor 206 to supervise the quality of the products received from the suppliers and to determine which supplier should be given the right to stock the warehouse.

24. The improved supply chain management system as claimed in claim 13, further comprises a return portal and a courier portal, and wherein the return portal and the Courier Portal is used for delivering the product and/or returning the product when not liked by the customer.

25. The improved supply chain management system as claimed in claim 13, further comprising different admin level portals selected from an admin, an accountant, customers, distributors, warehouses, suppliers, contractors, and a third Party, and each portal having respective IDs.

26. The improved supply chain management system as claimed in claim 13, wherein a website of the system displays information comprising at least one of the following: information concerning discounts, coupons and/or incentives available for the plurality of products, and information concerning the products availability at one or more of the warehouses.

27. The improved supply chain management system as claimed in claim 13, further comprising an in-store consumer device configured to generate a limited time, authentication code protected coupon based on the consumer information and the seller information. Any customer introducing a new customer is entitled for a “discount” or “Customer points” which the can redeem them on future purchases. The more customers they introduce the more “Customer points” they earn. If the customer they introduced also introduces new customers the original customer earns point for that too. Also according to the amount of purchases by the introduced customers under him the original customer will get extra “Customer points” which can be redeemed with each purchase or it can be cash rewards. There will be a separate “Customer Points Portal” to check how much each customer has earned.

28. A method for supply chain management system with an Integrated accounting Software Portal 207 to manage the portal including consumer, distributor, warehouse, supplier, quality assessor, contractor, accounts, third party, “Customer Points Portal” and all managements portals.
